(19) United States
(12) Patent Application Publication
(10) Pub. No.: US 2013/0103532 A1
(43) Pub. Date: Apr. 25, 2013

(54) AUCTION SYSTEM, AUCTION DEVICE, METHOD OF AUCTIONING, PROGRAM AND INFORMATION RECORDING MEDIUM

(71) Applicant: Sadaaki Emura, Shinagawa-ku (JP)

(72) Inventor: Sadaaki Emura, Shinagawa-ku (JP)

(73) Assignee: RAKUTEN, INC., Shinagawa-ku, Tokyo (JP)

(21) Appl. No.: 13/807,522

(22) PCT Filed: Jun. 22, 2011
(86) PCT No.: PCT/JP2011/064304

§ 371 Date: Dec. 28, 2012

(30) Foreign Application Priority Data
Jun. 30, 2010 (JP) 2010-150620

(51) Int. Cl. G06Q 30/08

(52) U.S. Cl. CPC G06Q 30/08
USPC 705/26.3

(57) ABSTRACT

Provided is an auction system capable of prompting a user to put up a popular item identified based on a bidding situation of an auction for auction. The auction device (10) stores, in association with at least some of users of the auction system, items that may be put up for auction by the at least some of user, identifies a successful item group based on at least one of a degree of deficiency in an item count in relation to a bidder count per item group constituted of items that share properties and a degree of rise of a current closing bid price in relation to a past closing bid price per item group, the degree of deficiency and the degree of rise being obtained based on results of bids on items that are put up for an auction, extracts users who may put up an item of the identified successful item group or a possible alternative thereto for auction, and recommends the extracted users to putting up an item of the successful item group or a possible alternative thereto for auction.

### TECHNICAL FIELD

The present invention relates to an auction system, an auction device, an auction method, a program, and an information recording medium.

### BACKGROUND ART

There have been auction systems which allow users to participate in an auction via the Internet. Patent Literature 1, for example, proposes a system for such auction systems which notifies an unsuccessful bidder of an item of an alternative to the item.

### CITATION LIST

### Patent Literature

[Patent Literature 1] JP 2010-44451 A

### SUMMARY OF INVENTION

### Technical Problem

The related art described above, however, does not increase the supply of an item and, in the case of a popular item, where the number of bidders surpasses the number of articles of an item that are being sold on an auction site, many people bid on an alternative to the popular item, too, and a closing bid price thus rises. As a result, a bidder may not succeed in obtaining a desired item no matter how many auctions he/she participates in.

The present invention has been made in view of the problem described above, and an object of the present invention is therefore to provide an auction system, an auction device, an auction method, a program, and an information recording medium which are capable of prompting a user to put up an item for auction based on what items are popular auction items.

### Solution to Problem

In order to achieve the above-mentioned object, according to the present invention, there is provided an auction system, which is connected to a seller terminal and a bidder terminal so as to be capable of communicating with each other, for running an auction in which an item put up for auction via the seller terminal is bought at the auction depending on a bid result of the bidder terminal, the auction system including: storing means for storing, in association with at least some of users of the auction system, one or more items that may be put up for auction by the at least some of users; identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by the auction system; extracting means for extracting, from the storing means, users who may put up an item of the successful item group or a possible alternative thereto; and information providing means for providing recommendation information for recommending putting up an item of the successful item group or a possible alternative thereto to the users extracted by the extracting means.

Further, according to an aspect of the present invention, the auction system further includes determining means for determining a target count based on at least one of the degree of deficiency and the degree of rise that are obtained for the successful item group identified by the identifying means, the target count being a number of recommendation targets who are recommended to put up an item for auction, in which the extracting means extracts from the storing means as many users as the target count determined by the determining means.

Further, according to an aspect of the present invention, the auction system further includes: auction information storing means for storing, for each of a plurality of auctions, information about an item and a running period of the each of the plurality of auctions, and information about one or a plurality of bidders and a bid price of each of the one or the plurality of bidders in association with each other; and bidder extracting means for extracting, from the auction information storing means, a bidder of an auction whose running period has expired who is not a successful bidder, whose bid price satisfies a given condition, and who has bid, after expiration of the running period of the auction, an auction of an item that belongs to the same item group as that of an item of the auction, in which the identifying means identifies, as the successful item group, an item group relevant to the auction on which the bidder extracted by the bidder extracting means bids.

Further, according to an aspect of the present invention, the storing means stores a seller of an auction run by the auction system for which a successful bidder has not been determined, in association with an item submitted for the auction.

Further, according to an aspect of the present invention, the storing means stores a successful bidder of an auction run by the auction system where an item has been bought, in association with the item bought in the auction.

Further, according to an aspect of the present invention, the auction system further includes determining means for determining a target count based on a bidder count per item of the successful item group, the target count being a number of targets to whom the recommendation information is to be provided, the bidder count being a number of bidders extracted by the bidder extracting means, in which the information providing means provides the recommendation information to as many users as the target count determined by the determining means.

Further, according to an aspect of the present invention, the auction system further includes means for evaluating, for each of the bidders extracted by the bidder extracting means, a weight of willingness to buy an item of the successful item group based on at least one of a bid count, a bid order, and a bid amount in auctions where items of the successful item group have been put up for auction, in which the determining means determines the target count based on a sum of weights of willingness to buy which are calculated for the respective bidders extracted by the bidder extracting means, the target count being the number of targets to whom the recommendation information is provided.

Further, according to an aspect of the present invention, the given condition is a condition that a difference between a bid price and a closing bid price be a given amount or less.

Further, according to the present invention, there is provided an auction device, which is connected to a seller terminal and a bidder terminal so as to be capable of communicating with each other, for running an auction in which an item put up for auction via the seller terminal is bought at the auction depending on a bid result of the bidder terminal, the auction device including: identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system; extracting means for extracting, from storing means, users who may put up an item of the successful item group or a possible alternative thereto, the storing means storing, in association with at least some of users of the auction system, one or more items that may be put up for auction by the at least some of users; and information providing means for providing recommendation information for recommending putting up an item of the successful item group or a possible alternative thereto to the users extracted by the extracting means.

Further, according to the present invention, there is provided an auction method for an auction system, which is connected to a seller terminal and a bidder terminal so as to be capable of communicating with each other, for running an auction in which an item put up for auction via the seller terminal is bought at the auction depending on a bid result of the bidder terminal, the auction method including: an identifying step of identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system; an extracting step of extracting, from storing means, users who may put up an item of the successful item group or a possible alternative thereto, the storing means storing, in association with at least some of users of the auction system, one or more items that may be put up for auction by the at least some of users; and an information providing step of providing recommendation information for recommending putting up an item of the successful item group or a possible alternative thereto to the users extracted by the extracting step.

Further, according to the present invention, there is provided a program for causing a computer to function, the computer being connected to a seller terminal and a bidder terminal so as to be capable of communicating with each other, for running an auction in which an item put up for auction via the seller terminal is bought at the auction depending on a bid result of the bidder terminal, the program causing the computer to function as: identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system; extracting means for extracting, from storing means, users who may put up an item of the successful item group or a possible alternative thereto, the storing means storing, in association with at least some of users of the auction system, one or more items that may be put up for auction by the at least some of users; and information providing means for providing recommendation information for recommending putting up an item of the successful item group or a possible alternative thereto to the users extracted by the extracting means.

Further, according to the present invention, there is provided an information recording medium having recorded thereon a program for causing a computer to function, the computer being connected to a seller terminal and a bidder terminal so as to be capable of communicating with each other, for running an auction in which an item put up for auction via the seller terminal is bought at the auction depending on a bid result of the bidder terminal, the program causing the computer to function as: identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system;

extracting means for extracting, from storing means, users who may put up an item of the successful item group or a possible alternative thereto, the storing means storing, in association with at least some of users of the auction system, one or more items that may be put up for auction by the at least some of users; and

information providing means for providing recommendation information for recommending putting up an item of the successful item group or a possible alternative thereto to the users extracted by the extracting means.

### Advantageous Effects of Invention

According to an aspect of the present invention, a user is prompted to put up an item for auction based on what items are popular auction items.

According to another aspect of the present invention, a number of users that is determined by the popularity of an item are prompted to put up an item for auction.

According to still another aspect of the present invention, a user is prompted to put up an item for auction based on what items are bid on by bidders who are willing to buy.

According to yet still another aspect of the present invention, a seller who has put up an article of an item bid on by bidders willing to buy, or a possible alternative to the item, for auction in the past but has not made a sale is prompted to put up the item or the alternative for auction.

According to yet still another aspect of the present invention, a successful bidder of an item bid on by bidders willing to buy, or a possible alternative to the item, in the past is prompted to put up the item or the alternative for auction.

According to yet still another aspect of the present invention, how many users are recommended to put up an item for auction is determined by the number of bidders who are willing to buy.

According to yet still another aspect of the present invention, bidders who are truly willing to buy are selected discriminately.

### BRIEF DESCRIPTION OF DRAWINGS

FIG. 1A system configuration diagram of an auction system according to an embodiment of the present invention.

FIG. 2 A functional block diagram of an auction device.

FIG. 3 A diagram illustrating an example of an item submission information table.

FIG. 4 A diagram illustrating an example of a bid information table.

FIG. 5 Diagrams illustrating bid information of a first auction and bid information of a second auction.

FIG. 6 A diagram illustrating an example of a prospective buyer information table.

FIG. 7 A diagram illustrating an example of a candidate auction item table.

FIG. 8 A diagram illustrating an example of recommendation information.

FIG. 9 A flow chart for processing of extracting prospective buyer candidates.

FIG. 10 A flow chart for processing of establishing a prospective buyer.

FIG. 11 A flow chart for first processing for identifying a successful item group from bidding situations of auctions.

FIG. 12 A flow chart for second processing for identifying a successful item group from bidding situations of auctions.

FIG. 13 A flow chart for processing of providing recommendation information to a recommendation target.

### DESCRIPTION OF EMBODIMENT

An embodiment mode for carrying out the present invention (hereinafter referred to as “embodiment”) is described below with reference to the drawings.

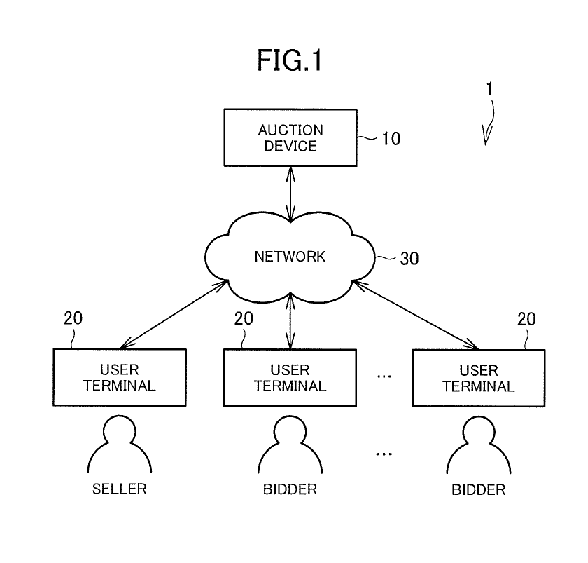

FIG. 1 illustrates a system configuration diagram of an auction system 1 according to this embodiment. As illustrated in FIG. 1, the auction system 1 includes an auction device 10 and one or a plurality of user terminals 20 each operated by a user who is a seller or bidder of an auction. The auction device 10 and the one or the plurality of user terminals 20 are connected via a network 30 such as the Internet so as to be capable of communicating data with each other.

The auction device 10 is a computer that receives item submission information and bid information from the user terminals 20 over the network 30, and runs an online auction based on the received item submission information and bid information. Details of functions installed in the auction device 10 are described later.

The user terminals 20 are computers respectively operated by a seller of an auction and a bidder of the auction. A browser is activated on each user terminal 20. Through the activated browser, the user terminal 20 transmits a processing request (an item submission request, a bid request, a request to provide auction information, or the like) to the auction device 10, which transmits to the user terminal 20 a processing result (page data written in a page description language) based on the processing request received from the user terminal 20, to thereby display a screen based on the processing result on a display that the user terminal 20 is equipped with.

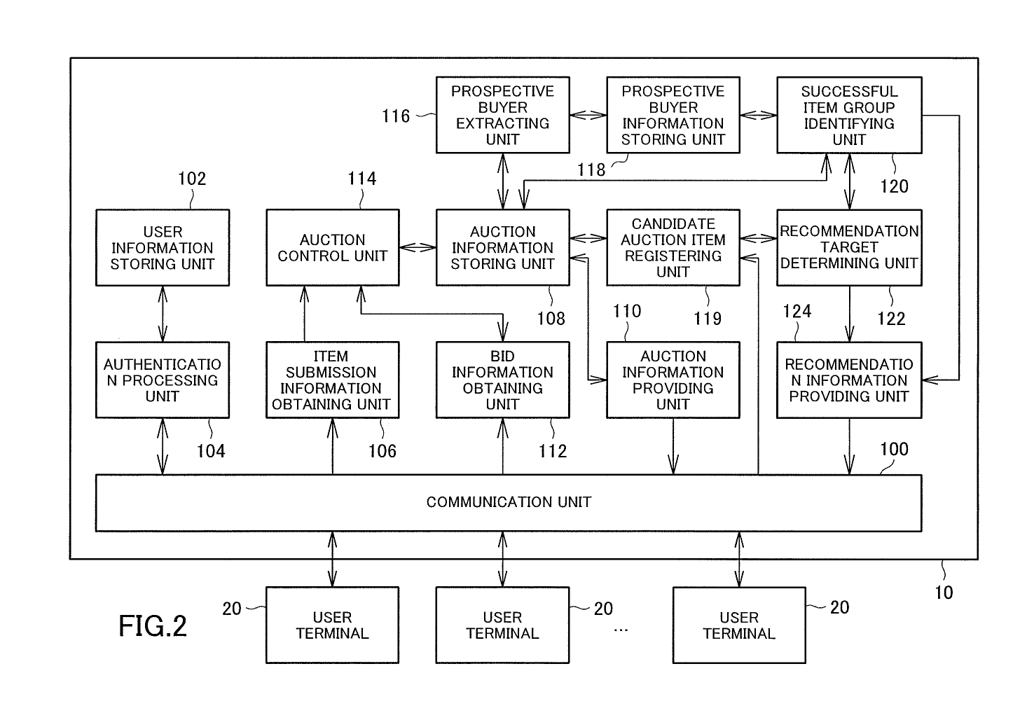

FIG. 2 illustrates a functional block diagram of the auction device 10 according to this embodiment. As illustrated in FIG. 2, the auction device 10 includes a communication unit 100, a user information storing unit 102, an authentication processing unit 104, an item submission information obtaining unit 106, an auction information storing unit 108, an auction information providing unit 110, a bid information obtaining unit 112, an auction control unit 114, a prospective buyer extracting unit 116, a prospective buyer information storing unit 118, a candidate auction item registering unit 119, a successful item group identifying unit 120, a recommendation target determining unit 122, and a recommendation information providing unit 124. Functions of the units given above can be implemented on a computer that includes control means such as a central processing unit (CPU), storage means such as a semiconductor memory or a magnetic disk device, and communication means such as a network interface by the control means by sequentially executing programs that are stored in the storage means. The programs may be supplied, in a state of being stored in an information recording medium such as an optical disc, a magnetic disk, magnetic tape, a magneto-optical disk, or a flash memory, to a computer that function as the auction device 10, or may be supplied to the computer via data communication means such as the Internet.

The communication unit 100 is implemented by a network interface, and communicates data to/from other computers connected via a network. The auction device 10 in this embodiment holds bi-directional data communication via the communication unit 100 to/from the user terminals 20 respectively operated by a seller and a bidder.

The user information storing unit 102 is for storing user information which is registered in order to use services of an online auction run by the auction device 10. For example, the user information storing unit 102 may store, in association with a user ID with which each user is identified, the name, e-mail address, and password of the user, among others.

The authentication processing unit 104 is for performing user authentication based on authentication information that is transmitted from each user terminal 20, such as a combination of a user ID and a password. In this embodiment, each user terminal 20 transmits a user ID and a password to the auction device 10 when accessing the auction device 10 for the first time, and the authentication processing unit 104 may grant the use of the auction device 10 in the case where the transmitted user ID and password match a combination of a user ID and a password that is stored in the user information storing unit 102 whereas the use of auction device 10 is denied otherwise. The auction device 10 transmits to the user terminal 20 successful authentication information which indicates that the use of the auction device 10 is granted to the user terminal 20, and the successful authentication information may be held in a cookie of the browser activated on the user terminal 20 so that, after the first access, whether to grant or deny the use of the auction device 10 to the user terminal 20 is determined based on cookie information transmitted from the user terminal 20.

The item submission information obtaining unit 106 is for obtaining item submission information of an auction from the user terminal 20 that is operated by a seller. For example, the item submission information obtaining unit 106 may receive and obtain, from the user terminal 20, in response to an operation made on the user terminal 20 by the seller, item submission information which includes the user ID of the seller, an item put up for the auction, a period in which the auction runs, and a minimum closing bid price.

The auction information storing unit 108 is for storing information about an auction run by the auction device 10 (which includes item submission information and bid information). For example, the auction information storing unit 108 stores item submission information obtained from the user terminal 20 of a seller by the item submission information obtaining unit 106.

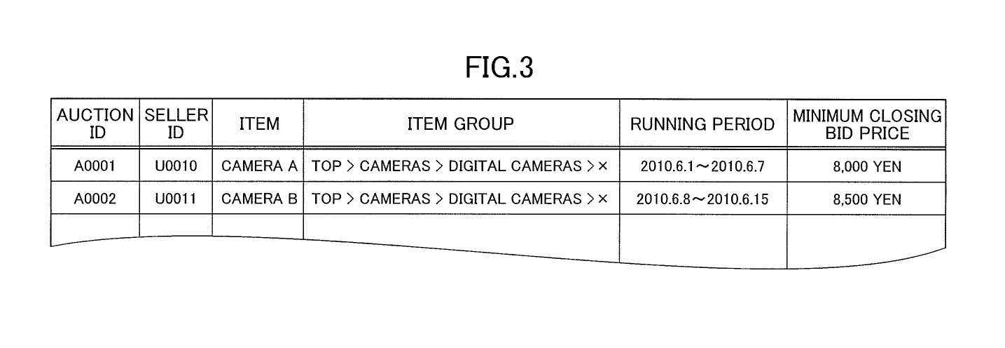

FIG. 3 illustrates an example of an item submission information table stored in the auction information storing unit 108. As illustrated in FIG. 3, the item submission information table holds, in association with an auction ID with which each auction which is run is identified, information about the user ID of a seller (a seller ID), an item put up for the auction, an item group to which the item belongs, a period in which the auction runs, and a minimum closing bid price. An item group is a group of items that have common attribution, for example, a group of items that belong to a common item category in an auction, or a group of items that share item attributes (e.g., an item name or a keyword).

The auction information providing unit 110 is for providing each user terminal 20 with information about an auction which is run based on item submission information stored in the auction information storing unit 108. The auction information providing unit 110 may provide the user terminal 20 with list information which includes at least some of ongoing auctions out of auctions stored in the auction information storing unit 108, or may further select auctions based on a page request or search query received from the user terminal 20 to provide information about the selected auctions to the user terminal 20.

The bid information obtaining unit 112 obtains information about a bid for an auction run on the auction device 10 from the user terminal 20 of a bidder. For example, the bid information obtaining unit 112 may receive and obtain, from the user terminal 20 of a bidder, bid information which includes an auction ID, a user ID with which the bidder is identified (a bidder ID), and a bid amount. Bid information obtained by the bid information obtaining unit 112 is stored sequentially in the auction information storing unit 108.

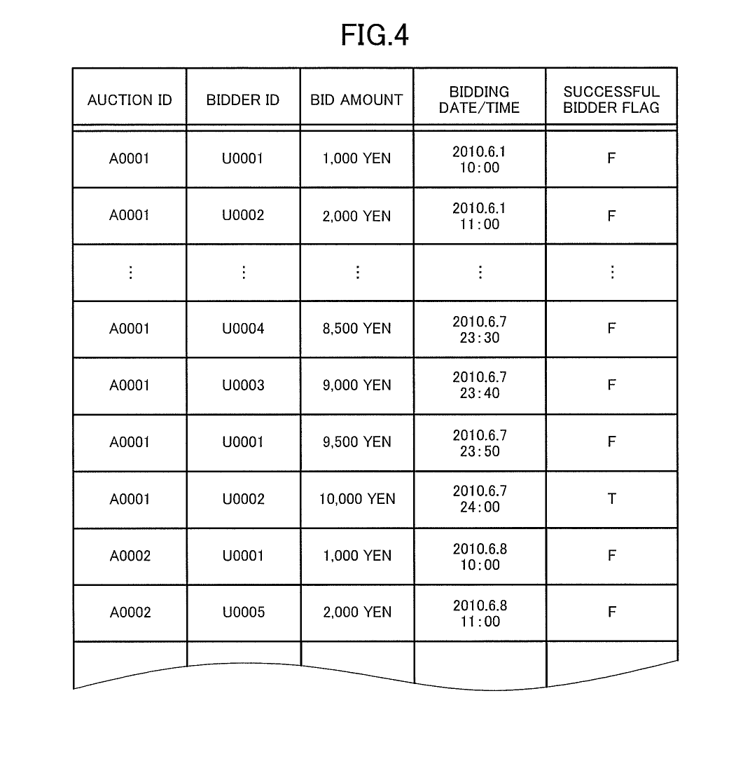

FIG. 4 illustrates an example of a bid information table stored in the auction information storing unit 108. The bid information table of FIG. 4 stores an auction ID, a user ID with which a bidder is identified (a bidder ID), a bid amount, a bidding date/time, and a successful bidder flag in association with one another. The bidding date/time can be, for example, a date/time when the bid information obtaining unit 112 has received bid information from the user terminal 20 of a bidder. The successful bidder flag is a truth-value with the default value set to “false (F)” and, when the successful bidder of an auction identified by an auction ID is determined, the value of the successful bidder flag is updated to “true (T)” in a record that indicates this bidder and the bid amount.

The auction control unit 114 is for controlling the start, running, and end of an auction based on item submission information which is obtained by the item submission information obtaining unit 106 and bid information which is obtained by the bid information obtaining unit 112. For example, the auction control unit 114 starts an auction based on item submission information stored in the auction information storing unit 108, updates auction state information which includes the current price, minimum opening bid price, and the like of the auction based on bid information stored in the auction information storing unit 108, and determines a bidder who has bid the highest bid price as the successful bidder when the running period of the auction ends. The auction control unit 114 may end an auction without determining the successful bidder of the auction in the case where the highest bid price does not reach a minimum closing bid price that is set to the auction.

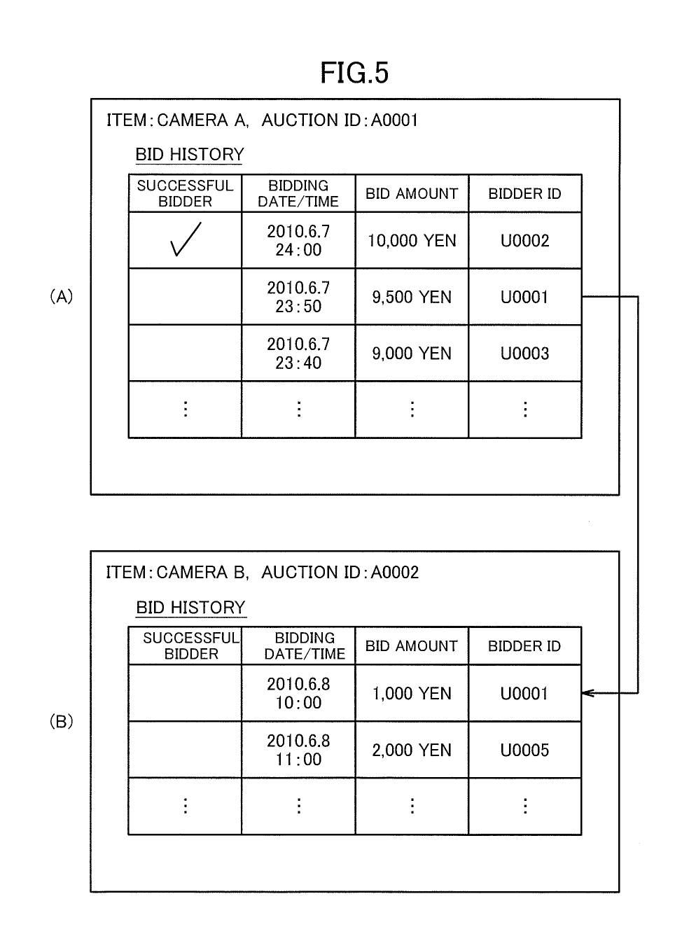

The prospective buyer extracting unit 116 is for extracting, from bid information stored in the auction information storing unit 108, a bidder of an expired auction who is not the successful bidder, whose bid amount satisfies a given condition, and who has bid after the expiration of the running period of this auction on an auction of an item that belongs to the same item group as the item of the expired auction. For example, the given condition may be that the difference between the bid amount and the closing bid amount be a given amount or less, or that the ratio of the bid amount to the closing bid amount be a given value or more, or that the bid amount in question land on a given place or higher when all bid amounts are sorted in descending order. A concrete description is given below with reference to FIG. 5 of bidder extracting processing executed by the prospective buyer extracting unit 116.

FIG. 5(A) illustrates bid information at the end of a first auction (auction ID: A0001) of an item A. As illustrated in FIG. 5(A), a user having a user ID “U0002” whose bid amount is the highest becomes the successful bidder at the end of the auction and, in the case of extracting a bidder whose bid amount differs from the closing bid amount by a given amount (e.g., 1,000 yen) or less, users having user IDs “U0001” and “U0003” are extracted as prospective buyer candidates.

FIG. 5(B) illustrates bid information of a second auction (auction ID: A0002) run after the first auction ends for an item B, which belongs to the same item group as the item A. As illustrated in FIG. 5(B), in the case where the user having a user ID “U0001” who has been extracted as a prospective buyer candidate is participating in the second auction, the user having a user ID “U0001” is established as a prospective buyer for the item group of the item A.

The prospective buyer information storing unit 118 stores information of prospective buyers extracted by the prospective buyer extracting unit 116.

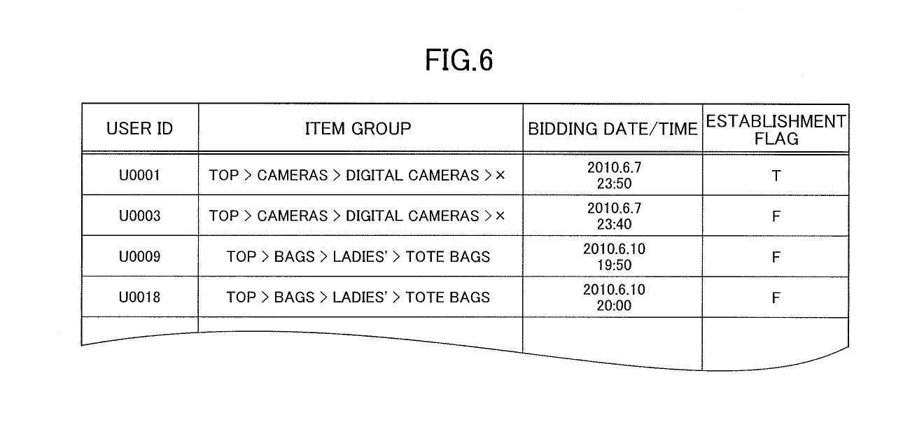

FIG. 6 illustrates an example of a prospective buyer information table stored in the prospective buyer information storing unit 118. As illustrated in FIG. 6, the prospective buyer information table stores, in association with the user ID of a user extracted as a prospective buyer candidate, the item group of an item on which the user has bid, a bidding date/time, and an establishment flag indicating that the user has been established as a prospective buyer. Specifically, the prospective buyer extracting unit 116 extracts from bid information stored in the auction information storing unit 108 a bidder of an expired auction who is not the successful bidder and whose bid amount satisfies a given condition. At this point, the bidder who satisfies the given condition has not bid after the expiration of the running period of this auction on an auction of an item that belongs to the same item group as the item of the expired auction. When a user having a user ID for which “unestablished” (false: F) is indicated by the establishment flag stored in the prospective buyer information table participates in an auction of an item belonging to an item group that is stored in the table in association with the user ID, the prospective buyer extracting unit 116 may update the establishment flag so as to indicate “established” (true: T).

The candidate auction item registering unit 119 registers, for each of at least some user IDs stored in the user information storing unit, information about an item that a user having the user ID may possibly put up for auction (a candidate auction item).

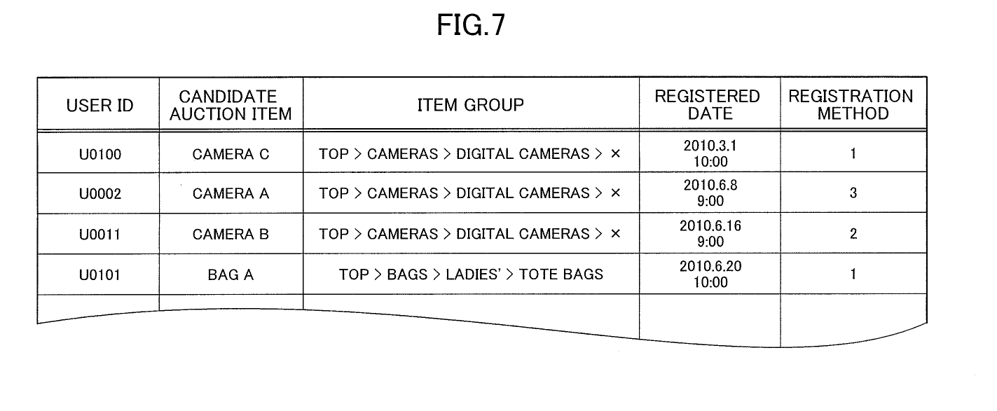

FIG. 7 illustrates an example of a candidate auction item table registered by the candidate auction item registering unit 119. As illustrated in FIG. 7, the candidate auction item table stores a user ID, a candidate auction item, the item group of the candidate auction item, a registered date, and a candidate auction item registration method (first to third registration methods) in association with one another. The candidate auction item registration method is information indicating which of the following three registration methods has been used to register information of a candidate auction item in the candidate auction item table. Each registration method is described below.

The first registration method registers an item for which a declaration has been made by a user that the user is agreeable to putting up the item for auction. Specifically, in the first registration method, the candidate auction item registering unit 119 receives information including a user ID and a candidate auction item from one of the user terminals 20, and registers the received information in the candidate auction item table.

The second registration method registers an item that has been put up for auction by a user in the past but has not been bought. Specifically, in the second registration method, the candidate auction item registering unit 119 searches the bid information table stored in the auction information storing unit 108 for an auction where an item has not been bought, and registers information about the found auction including the user ID of the seller and the item put up for auction in the candidate auction item table.

The third registration method registers an item on which a user has successfully bid in a past auction by deeming the item as a candidate for a future auction item. Specifically, in the third registration method, the candidate auction item registering unit 119 searches the bid information table stored in the auction information storing unit 108 for an auction where an item has been bought, and registers information about the found auction including the ID of the successful bidder and the item put up for auction in the candidate auction item table. In this case, the candidate auction item registering unit 119 may register in the candidate auction item table only when the item bought by the successful bidder is presumed as a surplus item to the successful bidder. For instance, whether an item is surplus to the successful bidder or not can be determined by whether or not the number of items that have been bought by the successful bidder and belong to the same item group is equal to or more than a threshold (e.g., 2). The threshold may be determined for each item group about which the determination is made. For example, the threshold may be set to a value larger than 2 for a group of items that a user is expected to own in multitudes, such as consumption articles.

The successful item group identifying unit 120 identifies an item group that is popular in auctions based on bidding situations of auctions that have been run. Specifically, the successful item group identifying unit 120 arbitrarily sets a target item group, studies auctions of items belonging to the target item group to obtain the degree of deficiency for the number of items in relation to the number of bidders (the degree of item deficiency), or the degree of rise for the current closing bid price in relation to a past closing bid price (the degree of rise in closing bid price), and identifies this target item group as a successful item group when the degree of item deficiency or the degree of rise in closing bid price exceeds a given reference. Details of successful item group identifying processing are described below.

For example, the successful item group identifying unit 120 obtains the number of submitted items and the number of bidders in ongoing auctions of items included in a target item group, or auctions that have been run within a given period of time (e.g., one day) from the current date/time for items of the target item group, to calculate the degree of item deficiency for the number of submitted items in relation to the number of bidders. The degree of item deficiency may be the number of bidders per item, or may be a value obtained by subtracting the number of submitted items from the number of bidders (the absolute deficiency count). When the degree of item deficiency calculated for a target item group is equal to or more than a threshold (or when the degree of item deficiency is larger than a threshold), the successful item group identifying unit 120 determines that the target item group is popular at present, and identifies the target item group as a successful item group.

To give another example, the successful item group identifying unit 120 calculates a current reference closing bid amount based on a statistic score such as the average value of closing bid amounts or the mode value in ongoing auctions of items included in a target item group, or auctions that have been run within a given period of time (e.g., one day) from the current date/time for items of the target item group. The successful item group identifying unit 120 further calculates a past reference closing bid amount based on a statistic score such as the average value of closing bid amounts or the mode value in auctions that have been run within a given period of time (e.g., one day) from a past reference time preceding the current time/date for items included in the target item group. The successful item group identifying unit 120 then calculates the degree of rise of the calculated current reference closing bid amount from the calculated past reference closing bid amount (the degree of rise in closing bid price). The degree of rise in closing bid price may be, for example, a value obtained by dividing the current reference closing bid amount by the past reference closing bid amount, a value obtained by subtracting the past reference closing bid amount from the current reference closing bid amount, a value obtained by subtracting the past reference closing bid amount from the current reference closing bid amount and dividing the difference by the length of time between the current date/time and the past reference time (the rate of rise), or the rate of increase of the current reference closing bid amount from the past reference closing bid amount. The past reference closing bid amount is not limited to the mode described above, and may be a statistic score such as the average value of closing bid amounts or the mode value in auctions that have been run at any point in the entire period for items included in a target item group. When the degree of rise in closing bid price calculated for a target item group is equal to or more than a threshold (or when the degree of rise in closing bid price is larger than a threshold), the successful item group identifying unit 120 determines that the target item group is popular at present, and identifies the target item group as a successful item group.

In the examples described above, the successful item group identifying unit 120 identifies a target item group as a successful item group when one of the degree of item deficiency and the degree of rise in closing bid price that are calculated for the target item group is equal to or more than a threshold (or the calculated degree is larger than a threshold). The successful item group identifying unit 120 may instead identify a target item group as a successful item group when the degree of item deficiency and the degree of rise in closing bid price are both equal to or more than their respective thresholds (or both are larger than their respective thresholds).

The recommendation target determining unit 122 determines the number of users to be recommended to put up an item for auction (a recommendation target count) and as many concrete user IDs as the recommendation target count based on a successful item group identified by the successful item group identifying unit 120. A concrete example of processing executed in the recommendation target determining unit 122 is described below.

The recommendation target determining unit 122 first determines a recommendation target count (U) based on the degree of item deficiency (S) and the degree of rise in closing bid price (T) that have been calculated for a successful item group. For example, the recommendation target determining unit 122 may calculate the recommendation target count (U) by an expression a·S+b·T, where a and b are each a predetermined coefficient equal to or more than 0. Needless to say, the recommendation target count (U) is not limited to the expression given above, and other calculation methods can be used as long as the calculated recommendation target count is higher when the degree of item deficiency (S) or the degree of rise in closing bid price (T) is higher.

The recommendation target determining unit 122 next selects as many user IDs as the calculated recommendation target count from user IDs that are registered in the candidate auction item table registered by the candidate auction item registering unit 119, based on the successful item group and the recommendation target count. A concrete description is given below of details of the user ID selecting processing.

The recommendation target determining unit 122 first executes processing of searching the candidate auction item table for a user ID associated with a candidate auction item that is an item of a successful item group or a possible alternative to an item of a successful item group, until the number of user IDs found reaches the recommendation target count. The possible alternative to an item of a successful item group is, for example, an item belonging to an item category different from that of the popular item but belonging to an upper item category that is the same as that of the popular item, or an item belonging to an item category similar to that of the popular item (which categories are similar to each other may be determined based on thesaurus information), or an item having the same function (and targeted buyer base) as those of the popular item. The association relation between items that can be an alternative to each other may be set in advance.

Specifically, the recommendation target determining unit 122 may search for a user ID associated with a candidate auction item that is an item of a successful item group, or a possible alternative thereto, by preferentially searching records of the candidate auction item table where the registration method is “1” and then searching records where the registration method is “2” in the case where the number of user IDs found in records where the registration method is “1” does not reach the recommendation target count. In the case where the total number of user IDs found in records where the registration method is “1” and records where the registration method is “2” does not reach the recommendation target count, the recommendation target determining unit 122 searches records where the registration method is “3” for a user ID that satisfies the criterion. In the case where the number of user IDs found exceeds the recommendation target count, for example, the recommendation target determining unit 122 may select user IDs chronologically by selecting user IDs that are associated with earlier registration dates/times.

The recommendation information providing unit 124 provides recommendation information which recommends putting up an item of a successful item group identified by the successful item group identifying unit 120, or a possible alternative thereto, for auction to each user ID determined by the recommendation target determining unit 122. For example, for each user ID determined by the recommendation target determining unit 122, the recommendation information providing unit 124 may transmit e-mail in which recommendation information is written to a mail address stored in the user information storing unit 102 in association with the user ID.

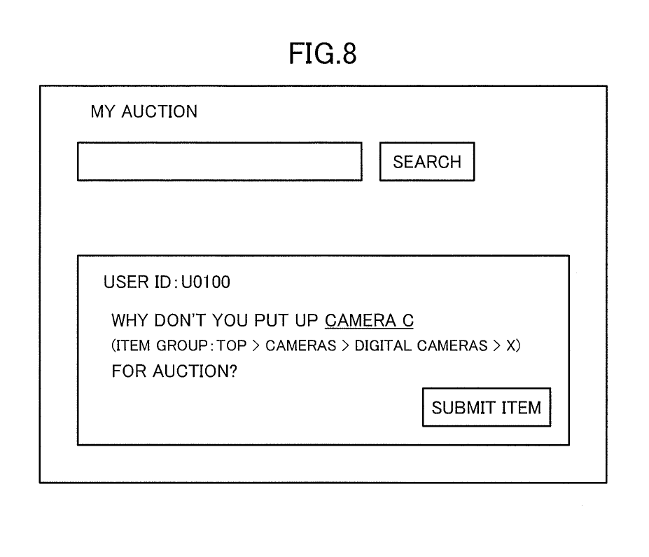

FIG. 8 illustrates an example of recommendation information provided by the recommendation information providing unit 124. As illustrated in FIG. 8, the recommendation information may be, for example, information for displaying, on a top page displayed after a user logs in, information that indicates a recommended auction item and information of a message that recommends putting up the item for auction. The recommendation information may instead be information transmitted to the e-mail address of a user to display information that indicates a recommended auction item, information of a message that recommends putting up the item for auction, and the URL of an auction. The recommended auction item may be set based on candidate auction items stored in the candidate auction item table in association with the user.

In the case where the item submission information obtaining unit 106 receives item submission information of an auction from a user having a user ID to which recommendation information has been provided by the recommendation information providing unit, the auction information providing unit 110 may notify, of information of this auction, a prospective buyer for an item group to which the item put up for the auction belongs. The prospective buyer for an item group to which the item put up for the auction belongs may be obtained by referring to the prospective buyer information table stored in the prospective buyer information storing unit 118.

When the item submission information obtaining unit 106 receives item submission information of an auction from a user having a user ID to which recommendation information has been provided by the recommendation information providing unit, the auction information providing unit 110 may also search the bid information table for a bidder who is bidding on an auction of an alternative to the item put up for this auction (e.g., an item belonging to the same item group) to notify the bidder of information about the auction of the newly submitted item.

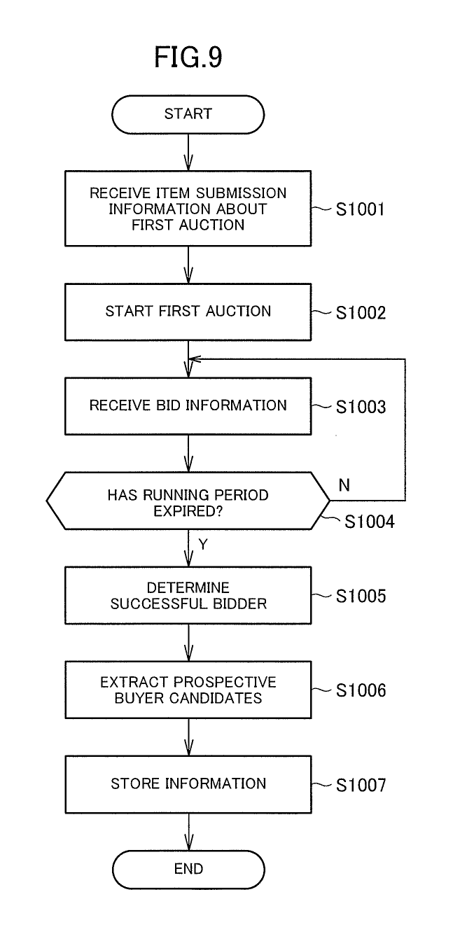

The flow of processing that is executed by the auction device 10 according to this embodiment is described next with reference to flow charts of FIGS. 9 to 13.

FIG. 9 illustrates an example of a flow chart for processing of extracting prospective buyer candidates. The auction device 10 first receives item submission information about a first auction from the user terminal 20 of a seller (S1001), and starts the first auction based on the received item submission information (S1002). The auction device 10 receives bid information for the first auction from the user terminal 20 of a bidder (S1003). When determining that a running period set to the first auction is about to expire (S1004: Y), the auction device 10 determines the successful bidder of the first auction based on the bid information received up to that point (S1005), and extracts each bidder whose bid amount differs from the closing bid price by a given amount or less as a prospective buyer candidate (S1006). The auction device 10 stores those pieces of information (S1007) and then ends the processing. When determining that the running period set to the first auction has not expired (S1004: N), the auction device 10 stands by to receive bid information.

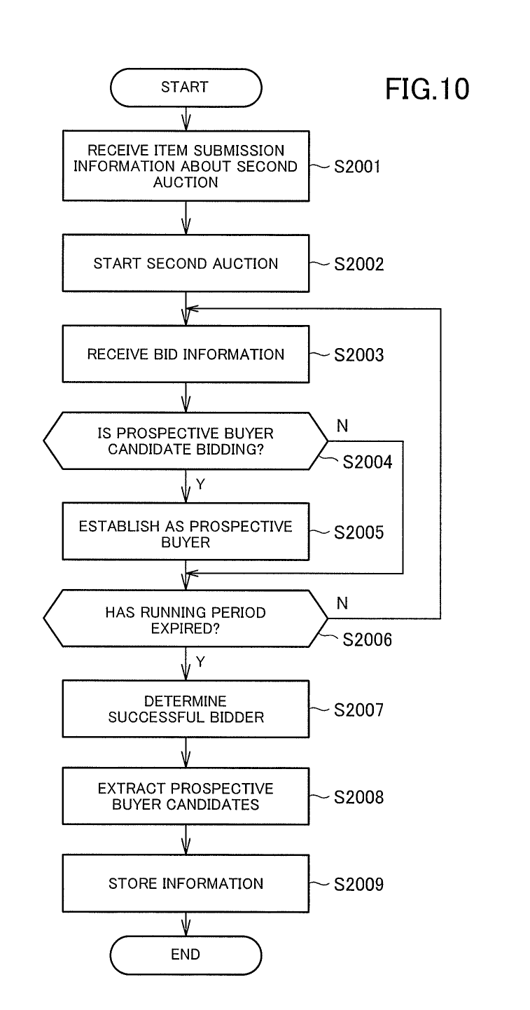

FIG. 10 illustrates an example of a flow chart for processing of establishing a prospective buyer. After the first auction ends, the auction device 10 receives item submission information about a second auction in which an item belonging to the same item group as that of the item of the first auction is put up for auction (S2001), and starts the second auction based on the received item submission information (S2002). The auction device 10 receives bid information for the second auction from the user terminal 20 of a bidder (S2003). In the case where it is determined from the received bid information that a prospective buyer candidate that has been extracted in the first auction is bidding (S2004: Y), the auction device 10 establishes this bidder as a prospective buyer (S2005). When determining that a running period set to the second auction is about to expire (S2006: Y), the auction device 10 determines the successful bidder of the second auction based on the bid information received up to that point (S2007), and extracts each bidder whose bid amount differs from the closing bid price by a given amount or less as a new prospective buyer candidate (S2008). The auction device 10 stores those pieces of information (S2009) and then ends the processing. In the case where it is determined that a prospective buyer candidate that has been extracted in the first auction is not bidding (S2004: N), the auction device 10 proceeds to S2006. When determining that the running period set to the second auction has not expired (S2006: N), the auction device 10 stands by to receive bid information. In the case where the auction device 10 receives, after the second auction ends, item submission information about a third auction in which an item belonging to the same item group as the item of the second auction is put up for auction, the auction device 10 may repeat the same flow as that of FIG. 9.

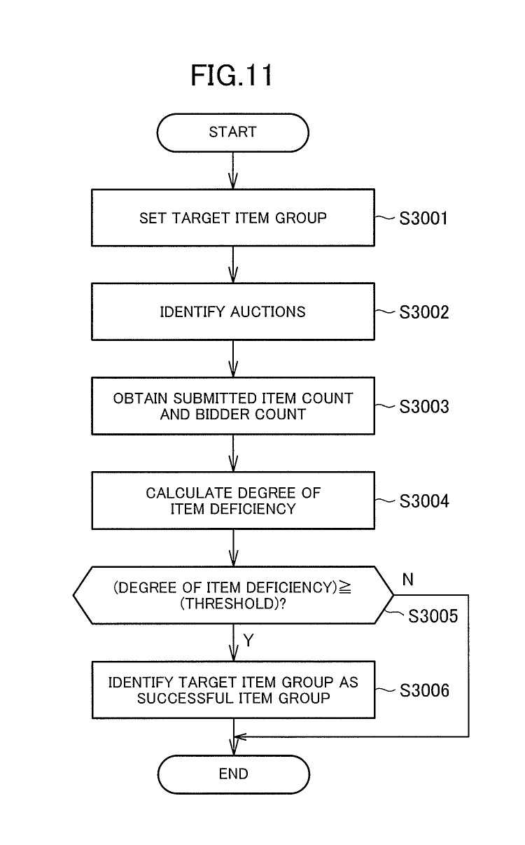

FIG. 11 illustrates an example of a flow chart for first processing for identifying a successful item group from bidding situations of auctions.

As illustrated in FIG. 11, the auction device 10 first sets a target item group (S3001). The auction device 10 may set a target item group every time an auction ends by selecting an item group to which the item submitted for the ended auction belongs, or may set a target item group by arbitrarily selecting one out of all item groups.

The auction device 10 identifies auctions that are run within a given period of time to put up items of the target item group for auction (S3002), and obtains the number of submitted items and the number of bidders in the identified auctions (S3003). The auction device 10 then calculates the degree of deficiency for the obtained number of items in relation to the obtained number of bidders (the degree of item deficiency) (S3004). The degree of item deficiency may be, for example, the number of bidders per item, or may be a value obtained by subtracting the number of items from the number of bidders.

In the case where the calculated degree of item deficiency is equal to or more than a threshold (S3005: Y), the auction device 10 identifies the target item group as an item group that is popular in auctions (S3006). In the case where the degree of item deficiency is less than the threshold (S3005: N), the auction device 10 does not identify the target item group as a successful item group, and ends the processing. The auction device 10 may repeat the processing described above by setting other item groups as a target item group one by one.

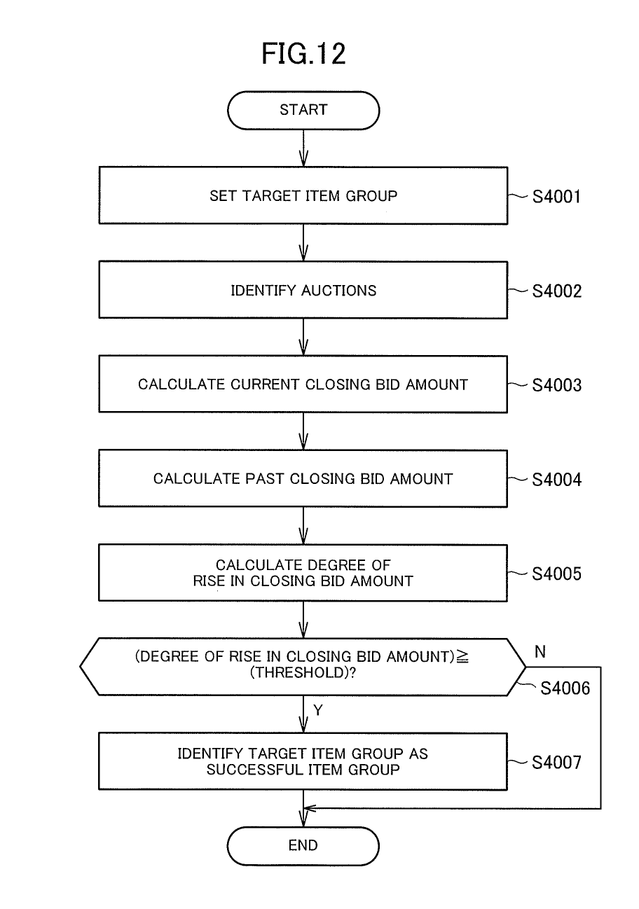

FIG. 12 illustrates an example of a flow chart for second processing for identifying a successful item group from bidding situations of auctions.

As illustrated in FIG. 12, the auction device 10 first sets a target item group (S4001). The auction device 10 may set a target item group every time an auction ends by selecting an item group to which the item submitted for the ended auction belongs, or may set a target item group by arbitrarily selecting one out of all item groups.

The auction device 10 identifies auctions in which items of the target item group are put up for auction (S4002). The auction device 10 calculates an average closing bid amount in some of the identified auctions that have been run within a given period of time from the current date/time (a current closing bid amount) (S4003), and calculates an average closing bid amount in auctions that have been run within a given period of time from a past point in time preceding the current time/date (a past closing bid amount) (S4004).

The auction device 10 next calculates the degree of rise of the calculated current closing bid amount from the calculated past closing bid amount (the degree of rise in closing bid amount) (S4005). The degree of rise in closing bid amount may be, for example, the ratio of the current closing bid amount to the past closing bid amount, or the rate of increase of the current closing bid amount from the past closing bid amount.

In the case where the degree of rise in closing bid amount is equal to or more than a threshold (S4006: Y), the auction device 10 identifies the target item group as an item group that is popular in auctions (S4007). In the case where the degree of rise in closing bid amount is less than the threshold (S4006: N), the auction device 10 does not identify the target item group as a successful item group, and ends the processing. The auction device 10 may repeat the processing described above by setting other item groups as a target item group one by one.

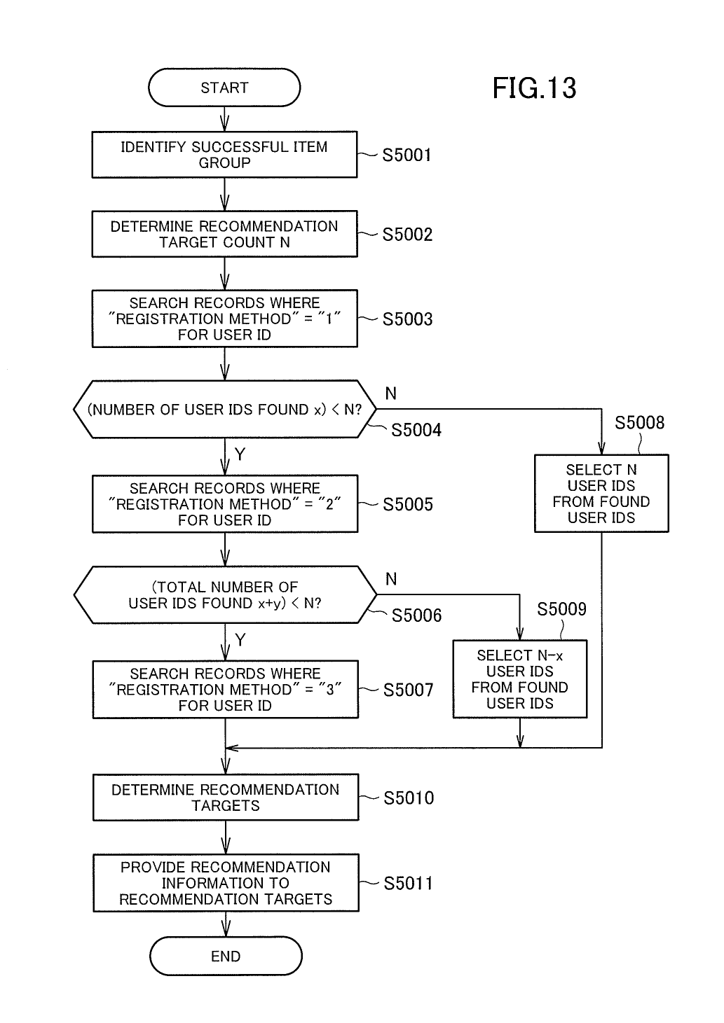

FIG. 13 illustrates an example of a flowchart for processing of recommending a user to put up for auction an item that is popular in auctions.

As illustrated in FIG. 13, the auction device 10 follows the flow of FIG. 11 or FIG. 12 described above to identify an item group that is popular in auctions (S5001), and then determines the number of users who are to be recommended to put up an item of this item group, or an alternative thereto, for auction (a recommendation target count: N) based on the degree of item deficiency or the degree of rise in closing bid amount that has been calculated for the item group (S5002).

The auction device 10 searches records of the candidate auction item table illustrated in FIG. 7 where the “registration method” is “1” for a user ID for which an item of the identified item group or an alternative thereto is registered as a candidate auction item (S5003). In the case where the number of user IDs found in S5003 (x) is less than the recommendation target count (N) (S5004: Y), the auction device 10 searches records of the candidate auction item table where the “registration method” is “2” for a user ID for which an item of the identified item group or an alternative thereto is registered as a candidate auction item (S5005). In the case where the total number of user IDs found in S5003 and S5005 (x+y) is less than the recommendation target count (N) (S5006: Y), the auction device 10 searches records of the candidate auction item table where the “registration method” is “3” for a user ID for which an item of the identified item group or an alternative thereto is registered as a candidate auction item (S5007).

In the case where the number of user IDs found in S5003 (x) is equal to or more than the recommendation target count (N) in S5004 (S5004: N), the auction device 10 selects as many user IDs as the recommendation target count (N) from the found user IDs (S5008). In the case where the total number of user IDs found in S5003 and S5005 (x+y) is equal to or more than the recommendation target count (N) in S5006 (S5006: N), the auction device 10 selects N-x user IDs from the user IDs found in S5005 (S5009).

The auction device 10 determines user IDs found in S5003, S5005, and S5007, or user IDs selected in S5008 or S5009, as recommendation targets (S5010), provides each of the determined recommendation targets with recommendation information which recommends putting up an item of the item group identified in S5001, or an alternative thereto, for auction (S5011), and ends the processing.

In the case where there are a plurality of successful item groups identified, the auction device 10 may execute the processing that follows the above-mentioned flow for each of the plurality of item groups.

The auction device 10 according to this embodiment can identify an item group that is popular in auctions and prompt a user to put up an item of the identified item group, or an alternative thereto, for auction. This quickly solves the deficiency in the quantity of items put up for auction that belong to a successful item group.

The present invention is not limited to the embodiment described above. For instance, the successful item group identifying unit 120 may identify, as a successful item group, an item group that includes an item on which a user extracted by the prospective buyer extracting unit 116 bids. Specifically, the successful item group identifying unit 120 may refer to the prospective buyer information table stored in the prospective buyer information storing unit 118 to identify, as a successful item group, an item group associated with a user ID that has “true” as the value of the establishment flag.

In this case, the recommendation target 122 may further determine the number of recommendation targets to whom recommendation information is provided (the recommendation target count (U)) based on the quotient of the total value of wi divided by N, when the number of items that are included in a successful item group identified by the successful item group identifying unit 120 is given as N, the total number of prospective buyers for the item group is given as M, and the weight of willingness to buy of each prospective buyer Pi (i represents a number from 1 to M) is given as wi (i represents a number from 1 to M). The weight of willingness to buy wi may be a fixed value irrespective of who the prospective buyer is, or may be calculated based a bid count (Xi), average place in bid order (Yi), and average bid amount (Zi) of the prospective buyer Pi in auctions relevant to a target item group. For example, when coefficients α, β, and γ are each equal to or more than 0 and an average closing bid amount of auctions relevant to the target item group is given as A, the weight wi may be calculated by an expression α·Xi+β/Yi+γ·Zi/A. Needless to say, the weight of willingness to buy (wi) of a prospective buyer is not limited to the expression given above, and other calculation methods can be used as long as the calculated weight of willingness to buy is larger when the bid count (Xi), the average place in bid order (Yi), and the average bid amount (Zi) are higher.

The auction device 10 configured as described above can prompt a user to put up an article of an item bid on by bidders who are willing to buy, for auction, and can further adjust the quantity of items supplied to solve the deficiency in item supply by changing the number of users who are prompted to put up an item for auction to suit the number of bidders who are willing to buy per item. This makes it easier for bidders to obtain a desired item at a fair price and enables sellers to know when is a good time to put up an item for auction.

The embodiment described above deals with an example in which the auction device 10 includes the user information storing unit 102 and the auction information storing unit 108. Needless to say, alternatively, information of all or some of the storing units may be stored in a database outside the auction device 10 so that the auction device 10 accesses the database to obtain the information.

1-12. (canceled)

13. An auction system, which is connected to a seller terminal and a bidder terminal so as to be capable of communicating with each other, for running an auction in which an item put up for auction via the seller terminal is bought at the auction depending on a bid result of the bidder terminal, the auction system comprising:
storing means for storing, in association with at least some of users of the auction system, one or more items that may be put up for auction by the at least some of users;
identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by the auction system;
extracting means for extracting, from the storing means, users who may put up an item of the successful item group or a possible alternative thereto; and
information providing means for providing recommendation information for recommending putting up an item of the successful item group or a possible alternative thereto to the users extracted by the extracting means.

14. The auction system according to claim 13, further comprising determining means for determining a target count based on at least one of the degree of deficiency and the degree of rise that are obtained for the successful item group identified by the identifying means, the target count being a number of recommendation targets who are recommended to put up an item for auction,
wherein the extracting means extracts from the storing means as many users as the target count determined by the determining means.

15. The auction system according to claim 13, further comprising:
auction information storing means for storing, for each of a plurality of auctions, information about an item and a running period of the each of the plurality of auctions, and information about one or a plurality of bidders and a bid price of each of the one or the plurality of bidders in association with each other; and
bidder extracting means for extracting, from the auction information storing means, a bidder of an auction whose running period has expired who is not a successful bidder, whose bid price satisfies a given condition, and who has bid, after expiration of the running period of the auction, an auction of an item that belongs to the same item group as that of an item of the auction,
wherein the identifying means identifies, as the successful item group, an item group relevant to the auction on which the bidder extracted by the bidder extracting means bids.

16. The auction system according to claim 13,
wherein the storing means stores a user who is a seller of an auction run by the auction system for which a successful bidder has not been determined, in association with an item that the seller has submitted for the auction as an item that the seller may put up for auction, and
wherein the extracting means extracts users associated with an item of the successful item group or a possible alternative thereto in the storing means as the item that may be put up for auction.

17. The auction system according to claim 13,
wherein the storing means stores a user who is a successful bidder of an auction run by the auction system where an item has been bought, in association with the item bought by the successful bidder in the auction as an item that the successful bidder may put up for auction, and
wherein the extracting means extracts users associated with an item of the successful item group or a possible alternative thereto in the storing means as the item that may be put up for auction.

18. The auction system according to claim 15, further comprising determining means for determining a target count based on a bidder count per item of the successful item group, the target count being a number of targets to whom the recommendation information is to be provided, the bidder count being a number of bidders extracted by the bidder extracting means,
wherein the information providing means provides the recommendation information to as many users as the target count determined by the determining means.

19. The auction system according to claim 18, further comprising means for evaluating, for each of the bidders extracted by the bidder extracting means, a weight of willingness to buy an item of the successful item group based on at least one of a bid count, a bid order, and a bid amount in auctions where items of the successful item group have been put up for auction,
wherein the determining means determines the target count based on a sum of weights of willingness to buy which are calculated for the respective bidders extracted by the bidder extracting means, the target count being the number of targets to whom the recommendation information is to be provided.

20. The auction system according to claim 15, wherein the given condition comprises a condition that a difference between a bid price and a closing bid price be a given amount or less.

21. An auction device, which is connected to a seller terminal and a bidder terminal so as to be capable of communicating with each other, for running an auction in which an item put up for auction via the seller terminal is bought at the auction depending on a bid result of the bidder terminal, the auction device comprising:
identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system;
extracting means for extracting, from storing means, users who may put up an item of the successful item group or a possible alternative thereto, the storing means storing, in association with at least some of users of the auction system, one or more items that may be put up for auction by the at least some of users; and
information providing means for providing recommendation information for recommending putting up an item of the successful item group or a possible alternative thereto to the users extracted by the extracting means.

22. An auction method for an auction system, which is connected to a seller terminal and a bidder terminal so as to be capable of communicating with each other, for running an auction in which an item put up for auction via the seller terminal is bought at the auction depending on a bid result of the bidder terminal, the auction method comprising:
an identifying step of identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system;
an extracting step of extracting, from storing means, users who may put up an item of the successful item group or a possible alternative thereto, the storing means storing, in association with at least some of users of the auction system, one or more items that may be put up for auction by the at least some of users; and
an information providing step of providing recommendation information for recommending putting up an item of the successful item group or a possible alternative thereto to the users extracted by the extracting step.

23. An information recording medium having recorded thereon a program for causing a computer to function, the computer being connected to a seller terminal and a bidder terminal so as to be capable of communicating with each other, for running an auction in which an item put up for auction via the seller terminal is bought at the auction depending on a bid result of the bidder terminal, the program causing the computer to function as:
identifying means for identifying a successful item group based on at least one of a degree of deficiency in the number of item in relation to the number of bidder per the item group constituted of items that have common attribution and a degree of rise of a current closing bid price in relation to a past closing bid price per the item group, the degree of deficiency and the degree of rise being obtained based on results of bids on items that put up for the auction by an auction system;
extracting means for extracting, from storing means, users who may put up an item of the successful item group or a possible alternative thereto, the storing means storing, in association with at least some of users of the auction system, one or more items that may be put up for auction by the at least some of users; and
information providing means for providing recommendation information for recommending putting up an item of the successful item group or a possible alternative thereto to the users extracted by the extracting means.
